(19) United States
(12) Patent Application Publication
(10) Pub. No.: US 2025/0027761 A1
(43) Pub. Date: Jan. 23, 2025

(54) METHOD AND APPARATUS FOR MEASURING THE THICKNESS OF ONE OR MORE LAYERS OF A MULTI-LAYER FILM OBTAINED BY BLOW EXTRUSION PROCESS

(71) Applicant: SYNCRO S.R.L., Busto Arsizio VA (IT)

(72) Inventor: Marco BRANCA, Busto Arsizio VA (IT)

(73) Assignee: SYNCRO S.R.L., Busto Arsizio VA (IT)

(21) Appl. No.: 18/711,297

(22) PCT Filed: Nov. 16, 2022
(86) PCT No.: PCT/IB2022/061030

§ 371 Date: May 17, 2024

(30) Foreign Application Priority Data
Nov. 19, 2021 (IT) 102021000029339

(51) Int. Cl. G01B 7/06

(52) U.S. Cl. CPC G01B 7/105; G01B 7/087

(57) ABSTRACT

A method is described for measuring, in a multi-layer film obtained by blow extrusion process and formed by one or more layers of a first material and a second material, the total thickness of the first material and/or the second material. The method includes the steps of: a) acquiring by means of an X-ray sensor a first measurement signal representative of the total thickness of the film; b) acquiring by means of a capacitive sensor a second measurement signal which is the sum of the signals given by the first and second materials of the film. The signal given by each material of the film is a function of the thickness of the material; and c) calculating, from the first and second signals, the total thickness (L₁ of the first material and/or the total thickness (L₂) of the second material.

### TECHNICAL FIELD OF THE INVENTION

The present invention relates to a process and apparatus for measuring the thickness of one or more layers of a multi-layer film, i.e. a film formed by a plurality of overlapping layers of different materials, wherein the multi-layer film is obtained by blow extrusion process.

More particularly, the present invention relates to a process and apparatus for measuring, in a multi-layer film formed by one or more layers of a first material and one or more layers of a second material, the total thickness of the first material (i.e. the thickness of the layer of the first material, in case the film contains only one layer of the first material, or the sum of the thicknesses of the layers of the first material, in case the film contains several layers of the first material) and the total thickness of the second material (i.e. the thickness of the layer of the second material, in case the film contains only one layer of the second material, or the sum of the thicknesses of the layers of the second material, in case the film contains several layers of the second material).

### STATE OF THE ART

The use of multi-layer films comprising one or more so-called “barrier” inner layers, whose function is to prevent the passage of gases, in particular oxygen, is widespread, for example in the food industry. Such barrier layers are for example made of EVOH. In a multi-layer film there may be one or more barrier layers, normally arranged within the film, with adjacent layers of other material. The multi-layer film may for example comprise the following sequence of three layers: neutral material, EVOH, neutral material, where the neutral material is for example polyethylene. In the case of two barrier layers, the multi-layer film may for example comprise the following sequence of five layers: neutral material, EVOH, neutral material, EVOH, neutral material.

Knowing in-line the exact thickness of the individual layers of a multi-layer film, in particular of the barrier layer, if any, would offer several advantages to the manufacturers of multi-layer films, such as the possibility to monitor the product precisely, the possibility to detect any defects in the composition of the individual layers of the film at an early stage, and the possibility to modify and develop the film recipe, if necessary, with a direct in-line control. There is therefore a need to provide manufacturers of multi-layer films with a solution that allows them to reliably, quickly and effectively measure the thickness of the individual layers of a multi-layer film.

Solutions for measuring the thickness of individual layers of a multi-layer film are already known, but they suffer from a number of drawbacks, in particular the fact that they do not allow a quick and conveniently applicable in-line measurement of the thickness of the layer(s) of material of interest.

For example, EP2026032 discloses a method for measuring the thickness of a layer of a first material in a film also comprising a second material, based on the comparison of the signal obtained by a measuring device, in particular a capacitive one, when the layer in question is present, with the signal obtained when the layer in question is not present, i.e. when the film consists only of the second material.

EP1205293 discloses a method for measuring the thickness of a layer of material in a multi-layer film based on performing several capacitance measurements under different conditions, in particular at different temperatures.

DE102011051601 discloses a system for measuring the thickness of a flat material, such as a plastic film, using an inductive sensor and an optical sensor mounted coaxially to the inductive sensor, wherein the inductive sensor measures the distance from the bottom side of the flat material, wherein the optical sensor measures the distance from the top side of the flat material, and wherein the thickness of the flat material is derived as the difference between the two distances thus measured. This system does not allow to measure the thickness of the various layers of material of a multi-layer material.

Furthermore, EP1969304 discloses a method for determining the thickness of multi-layer films comprising layers of various non-conductive materials, using a first sensor, a second sensor and possibly further sensors. The first sensor measures the overall thickness profile of the film with a short measurement cycle lasting approximately 1-2 minutes, but with a considerable margin of error, while the second sensor measures the overall thickness profile of the film with a small margin of error, but with a measurement cycle lasting longer, approximately 10 to 30 minutes. By comparing the two thickness profiles thus obtained, a correction profile is calculated for the first sensor, which can be applied to all thickness profiles measured by that sensor, until a more accurate thickness profile becomes available from the second sensor with which to calculate a new correction profile.

### SUMMARY OF THE INVENTION

It is an object of the present invention to provide a method and apparatus for measuring in-line, i.e. during the production process of a multi-layer film, the thickness of a layer, in particular a layer of barrier material, of the film, in particular in the case of a film obtained by blow extrusion process.

This and other objects are fully achieved, according to a first aspect of the present invention, by a method as defined in the appended independent claim 1 and, according to a further aspect of the present invention, by an apparatus as defined in the appended independent claim 8.

Advantageous ways for carrying out the method according to the invention, as well as advantageous embodiments of the apparatus according to the invention, are defined in the dependent claims, the subject-matter of which is to be understood as forming an integral part of the present description.

In summary, the invention is based on the idea of using a first electromagnetic radiation sensor, for example an X-ray retro-reflection sensor, and a second capacitive sensor arranged on the same measuring head so as to face the outer surface of the bubble. The first sensor (electromagnetic radiation sensor) is advantageously chosen with a sufficiently high energy so that the absorption coefficients of the two materials converge to the same value minus a negligible error; in this way, the first sensor is able to measure the total thickness of the film independently of the composition and materials of the film. The second sensor (capacitive sensor) is configured to provide a measurement signal that is the sum of the signals given by the first and second material of the film, wherein the signal given by each material of the film is a function of the thickness of that material (in case of several layers of the same material, the total thickness of those layers).

Driving means are associated with the measuring head carrying the two sensors to control the movement of the measuring head along a circular path around the bubble, so that the thickness can be measured along the entire perimeter of the bubble. The first and second sensors are arranged one above the other, at the shortest possible distance from each other, in a same plane oriented tangentially with respect to the outer surface of the bubble.

Preferably, the measuring head further comprises a third sensor, in particular an ultrasonic sensor, for measuring the distance between the measuring head and the outer surface of the bubble so as to ensure that the measuring conditions, in particular the contact of the active face of the sensor with the bubble or their respective distance, are always ensured and monitored.

The measurement system according to the invention, therefore, does not provide for the dependence on values, such as the dielectric constants of the film materials, as proposed in the aforementioned document EP1969304, which are to be provided in advance to the system leaving the possibility of introducing errors into the measurement evaluation. A source of error can be in particular the temperature, as the dielectric constants vary even more than 100 percent depending on the temperature of the material. The same can apply to intrinsic disturbances or differences between one machine and another or between one sensor and another, which makes it difficult to provide correct values of the measured quantities, unless samples and lengthy on-site sampling methods are used. The measuring system according to the invention makes it possible to directly obtain the values L₁ and L₂ of the thickness of the layer(s) of the first material (for example a neutral material, such as polyethylene) and respectively of the thickness of the layer(s) of the second material (for example a barrier material, such as EVOH) from the signal Sₓ provided by the first sensor and the signal S_{cap} provided by the second sensor, based on the following system of equations:

$$\begin{matrix}{S}_{X} = {k}_{X} \cdot ( {L}_{1} + {L}_{2} ) ; & ( 1 ) \\ {S}_{cap} = {k}_{1} \cdot {L}_{1} + {k}_{2} \cdot {L}_{2} . & ( 2 )\end{matrix}$$

The parameter kₓ (which is a common parameter for the two materials since, as mentioned, the electromagnetic radiation sensor is chosen so that the absorption coefficients of the two materials are substantially equal) is continuously derived from the data of the dosing devices of the plant, for example gravimetric dosing devices, which measure the quantities of the first material and the second material fed into the plant and thus provide the average total thickness L̅₁̅+L̅₂̅, thus ensuring that the signal Sₓ provided by the first sensor corresponds to the absolute measurement of the total thickness of the film. The parameters k₁ and k₂, on the other hand, can be determined in the following way: the parameter k₁ can be determined, during the first start-up phase of the film production plant, based on the signal S_{cap} provided by the second sensor when the film is formed by the first material only (and therefore L₂₌₀); the parameter k₂ is obtained from equation (2) using the average value of the signal S_{cap} and the average values of L₁ and L₂, based on the following equation:

$${k}_{2} = ( \overline{{S}_{cap}} - {k}_{1} \cdot \overline{{L}_{1}} ) / \overline{{L}_{2}} . \qquad ( 3 )$$

The average values of L₁ and L₂ are preferably provided by the above-mentioned dosing devices, but can alternatively be manually set by the operator as equal to the nominal values of L₁ and L₂.

The measuring system is thus able to calibrate itself continuously with no external intervention and can be used on any material without the need to know its dielectric constant value in advance, which eliminates a considerable source of error.

The fact that the measurement obtained with such a measuring system does not depend on the environmental conditions of the material, for example the temperature, also eliminates an additional source of error.

A further advantage of the measuring system according to the invention is that the system does not require any further operations, for calibration purposes, than those which are already normally performed on the plant. For example, operating the system to produce the neutral film only, without barrier layer(s), is an operation that is already commonly performed when the plant is switched on, so that the calculation of the parameter k₁ in the manner illustrated above does not require performing a special operating step.

Furthermore, the measuring system operates correctly regardless of whether the layers to be measured are coloured, opaque or transparent. The only requirement is that the first material and the second material have dielectric constants that differ from each other, albeit by a small amount. This is usually not a problem for materials (for example PE and EVOH) commonly used for multi-layer films provided with barrier layer(s), even under standard ambient temperature conditions. Thus, there is no need for a temperature higher than standard room temperature to increase the dielectric difference between the materials, as it has been found experimentally that even at standard room temperature the invention can detect thicknesses in the order of a single micron of EVOH in a few tens of microns of PE.

A further advantage of the present invention is that the sensors operate at close range to each other, and thus under the same ambient conditions, and can be used directly in the bubble phase, which is especially useful in large plants which, due to their size, are not equipped with a rotating haul-off head, which would prevent the bubble profile from being reconstructed if the film were measured in the form of a flattened tube.

The measuring system also makes it possible to measure the thickness of the layers of a film formed by more than two materials, provided that these materials are “similar”, i.e. are characterised by substantially equal relationships between the thickness and the signal generated by the second sensor (capacitive sensor). The measuring system in this case measures the thickness of the layers of two or more “similar” material as if they were layers of the same material. For example, in a multi-layer film having in sequence a layer of neutral material, a layer of a first barrier material, a layer of a second barrier material, a further layer of the first barrier material and a further layer of the neutral material, where the two barrier materials are different materials but characterized by substantially similar thickness-capacitive signal relationships, the measuring system would be able to measure the sum L₁ of the thicknesses of the two layers of neutral material and the sum L₂ of the thicknesses of the two layers of the first barrier material and the layer of the second barrier material.

### BRIEF DESCRIPTION OF THE DRAWINGS

Further features and advantages of the present invention will become clearer from the following description, given purely by way of non-limiting example with reference to the accompanying drawings, in which:

FIG. 1 is a perspective view of an apparatus for measuring the thickness of one or more layers of a multi-layer film according to an embodiment of the present invention; and

FIG. 2 is a perspective view showing on an enlarged scale the measuring head of the apparatus of FIG. 1.

### DETAILED DESCRIPTION

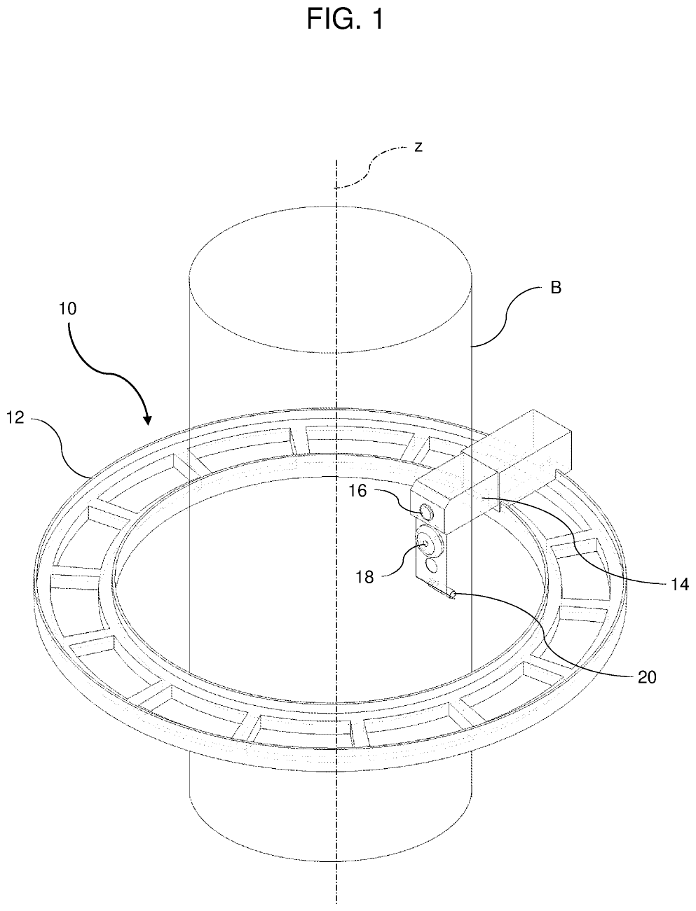

Referring first to FIG. 1, a measuring apparatus configured to measure the thickness of one or more layers of a multi-layer film, in particular a multi-layer film comprising one or more layers of a first material and one or more layers of a second material, is generally indicated 10. In the following description reference will be made to the case in which the film comprises a pair of outer layers of PE as the first material and an inner layer of EVOH as the second material, but it is clear that the invention is also applicable to the measurement of the thickness of layers of multi-layer films having a different number of layers and/or a different composition.

More specifically, the measuring apparatus 10 is intended to be used in a plant for the production of multi-layer films by blow extrusion process, in particular in a plant in which the haul-off means are fixed, i.e. do not rotate.

The measuring apparatus 10 comprises a thrust bearing 12 (or, more generally, other guide means) arranged around the bubble B (the axis of which is denoted by z), coaxially thereto, and a measuring head 14 which is mounted on the thrust bearing 12 so as to be movable in a horizontal plane (i.e. in a plane perpendicular to the axis z of the bubble B) along a circular path around the bubble B. Driving means (not shown, but anyway of a per-se-known type) are associated with the measuring head 14 for controlling the movement of the measuring head 14 along the aforementioned circular path on the thrust bearing 12.

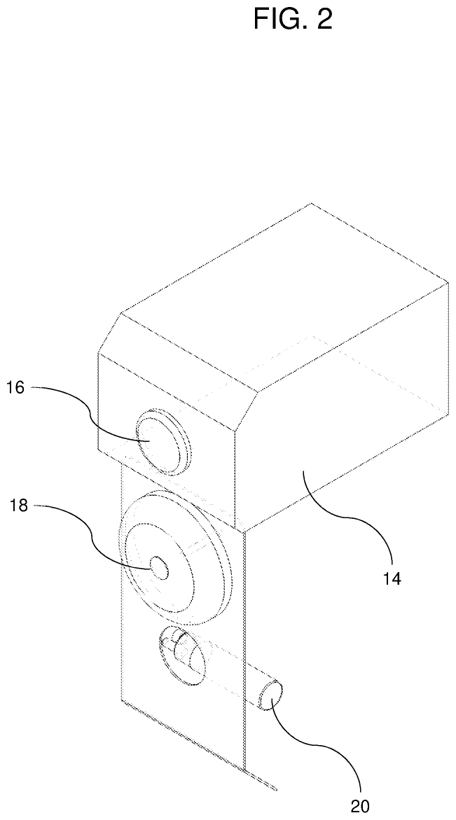

With reference also to FIG. 2, the measuring head 14 is provided with an electromagnetic radiation sensor 16, in particular an X-ray retro-reflection sensor, and a capacitive sensor 18, both arranged facing the outer surface of the bubble B, at a certain distance therefrom. The two sensors 16 and 18 are positioned one above the other, at a certain distance from each other, in a same plane oriented tangentially with respect to the outer surface of the bubble B.

Preferably, the measurements with the two sensors 16 and 18 will be performed at different times, in particular with a delay from each other corresponding to the time required for the same point on the bubble B to travel the distance separating the two sensors. Thus, depending on the linear speed with which the bubble B moves upwards, the measurement of the electromagnetic radiation sensor 16 will be performed with a certain delay with respect to the measurement performed by the capacitive sensor 18 so that the two sensors measure the thickness of the bubble B at exactly the same point each time.

Preferably, the measuring head 14 is moved at discrete intervals around the bubble, taking the measurement with the two sensors at a given angular position, then moving by a certain angle and taking a new measurement with the two sensors, and so on. Preferably, the measuring head 14 further comprises a third sensor 20, in particular an ultrasonic sensor, arranged to measure the distance between the measuring head 14, and thus the plane in which the two sensors 16 and 18 lie, and the outer surface of the bubble B.

As explained above, given a multi-layer film comprising one or more layers of a first material (for example a neutral material, such as PE) of total thickness L₁ and one or more layers of a second material (for example a barrier material, such as EVOH) of total thickness L₂, the values of the thicknesses L₁ and L₂ will be calculated by appropriate processing means (per se known) by solving the system of equations (1) and (2) above based on the values of the signals Sₓ and S_{cap} supplied to such processing means by the electromagnetic radiation sensor and the capacitive sensor, respectively. With regard to the parameters k₁ and k₂ appearing in equation (2), the former will advantageously be determined, during the first start-up phase of the film production plant, based on the signal S_{cap} provided by the capacitive sensor when the film is formed by the first material only (and therefore L₂₌₀), while the latter will advantageously be determined during operation by equation (3) above, based on the average value of the signal S_{cap} and the average values of L₁ and L₂. The average values of L₁ and L₂ are preferably provided by the dosing devices, for example gravimetric dosing devices, which measure the quantities of the first material and the second material fed into the plant. Alternatively, the average values of L₁ and L₂ can be set manually by the operator during calibration, as equal to the nominal values of L₁ and L₂.

As an example, the measurement method is illustrated here in the case of a multi-layer film with a total thickness of 30 μm, of which 25 μm consists of PE and 5 μm consists of EVOH, and with a structure comprising a first 12.5 μm layer of PE, a 5 μm layer of EVOH and a second 12.5 μm layer of PE.

Once started-up, the plant will begin to produce a 25 μm film of PE, whereby the electromagnetic radiation sensor will provide a measurement signal Sₓ, as a result of the calibration with the production recorded by the dosing devices, equal to:

Sₓ=L₁=25 μm.

During this phase, the capacitive sensor will be measuring a non-calibrated (and therefore non-important) value, for example 40 μm. Equation (2) above will then become (L₂ being equal to 0):

$${S}_{cap} = {k}_{1} \cdot {L}_{2} = 40 μm .$$

By entering the value L₁₌₂₅ μm measured with the electromagnetic radiation sensor, the value of the first calibration coefficient is obtained:

K₁=S_{cap}/L₁=40 μm/25 μm=1,6.

When EVOH is introduced into the line, and thus the film contains both the layers of thickness L₁ and the layers of thickness L₂, the electromagnetic radiation sensor will provide a measurement signal

$${S}_{X} = {L}_{1} + {L}_{2} = 30 μm ,$$

while the capacitive sensor will still provide a non-calibrated measurement signal, for example 50 μm. The relationship (2) above will then become:

$${S}_{cap} = 1 , 6 \cdot {L}_{1} + {k}_{2} \cdot {L}_{2} = 50 μm .$$

At this point, a second calibration is performed to determine the coefficient k₂, using the average values of L₁ and L₂, i.e. L₁₌₂₅ μm and L₂₌₅ μm, which are for example provided by the dosing devices of the plant or entered manually by the operator based on the nominal values or based on the values measured in laboratory.

From the previous relationship, the following one is obtained:

$${k}_{2} = ( 50 μm - 1 , 6 \cdot 25 μm ) / 5 μm = 2.$$

From this time onwards, the measuring apparatus will therefore be able to measure the thickness L₂ at any time.

If for some reason the plant were then to produce a film with a varied structure, for example with a first layer of PE of 12 μm thickness, with an intermediate layer of EVOH of 6 μm thickness and with a second layer of PE of 14 μm thickness, the electromagnetic radiation sensor and the capacitive sensor would provide the following signals:

$${S}_{X} = 26 μm + 6 μm = 32 μm \\ {S}_{cap} = 1 , 6 \cdot 26 μm + 2 \cdot 6 μm = 53 , 6 μm .$$

Based on these values of the signals Sₓ and S_{cap} provided by the electromagnetic radiation sensor and the capacitive sensor, respectively, as well as the values of the parameters k₁ and k₂ determined as described above, the measuring apparatus calculates the thicknesses L₁ and L₂ by solving the system of equations (1) and (2) and thus obtains the following results (which correspond exactly to the sum of the thicknesses of the two layers of PE and the thickness of the intermediate layer of EVOH):

$${L}_{2} = ( ( {S}_{cap} - {k}_{1} \cdot {S}_{X} ) / ( {k}_{2} - {k}_{1} ) = ( 53 , 6 μm - 1 , 6 \cdot 32 μm ) / ( 2 - 1 , 6 ) = 6 μm \\ {L}_{1} = {S}_{X} - {L}_{2} = 32 μm - 6 μm = 26 μm .$$

The present invention has been described so far with reference to a preferred example thereof. It is to be understood that other embodiments and modes of carrying out the invention may be envisaged, which are based on the same inventive core as defined by the appended claims.

1. A method for measuring, during production by blow extrusion process of a multi-layer film formed by one or more layers of a first material and one or more layers of a second material, the total thickness (L₁) of the first material and/or the total thickness (L₂) of the second material, comprising:
(a) acquiring by means of an electromagnetic radiation sensor a first measurement signal (Sₓ) representative of the total thickness of the film;
(b) acquiring by means of a capacitive sensor a second measuring signal (S_{cap}) which is the sum of the signals given by the first and the second material of the film, wherein the signal given by each material of the film is a function of the thickness (L₁, L₂) of that material; and
(c) calculating, from said first and second measurement signals (Sₓ, S_{cap}), the total thickness (L₁) of the first material and/or the total thickness (L₂) of the second material.

2. The method according to claim 1, wherein said electromagnetic radiation sensor is an X-ray retro-reflection sensor.

3. The method according to claim 1, wherein said steps a) and b) of acquiring a first measurement signal (Sₓ) by means of an electromagnetic radiation sensor and acquiring a second measurement signal (S_{cap}) by means of a capacitive sensor, are performed with said sensors arranged facing an outer surface of the bubble (B).

4. The method according to claim 3, wherein said steps a) and b) of acquiring a first measurement signal (Sₓ) by means of an electromagnetic radiation sensor and acquiring a second measurement signal (S_{cap}) by means of a capacitive sensor, respectively, are performed with said sensors arranged above each other and at a certain distance from each other, in a same plane oriented tangentially with respect to an outer surface of the bubble (B).

5. The method according to claim 4, further comprising the step of measuring the distance of said plane from the outer surface of the bubble (B) by means of an ultrasonic sensor.

6. The method according to claim 2, wherein said steps a) and b) of acquiring a first measurement signal (Sₓ) by means of an electromagnetic radiation sensor and acquiring a second measurement signal (S_{cap}) by means of a capacitive sensor, respectively, are performed by moving said sensors along a circular path around the bubble (B).

7. The method according to claim 1, wherein said step c) of calculating the total thickness (L₁) of the first material and/or the total thickness (L₂) of the second material is based on solving the following system of equations:
$${S}_{X} = {k}_{X} \cdot ( {L}_{1} + {L}_{2} ) \\ {S}_{cap} = {k}_{1} \cdot {L}_{1} + {k}_{2} \cdot {L}_{2} ,$$
wherein the parameter kₓ is continuously derived from data supplied by dosing means of the film production plant, which measure the quantities of the first material and the second material fed into the plant,
wherein the parameter k₁ is determined, during the start-up phase of the film production plant, based on the value of said second measurement signal (S_{cap}) when the film (F) is formed by the first material only, and
wherein the parameter k₂ is determined during the film production cycle, based on the average value of said second measurement signal (S_{cap}) and the average values of the total thickness (L₁) of the first material and the total thickness (L₂) of the second material provided by said dosing means, from the following equation:
$${k}_{2} = ( \overline{{S}_{cap}} - {k}_{1} \cdot \overline{{L}_{1}} ) / \overline{{L}_{2}} .$$

8. An apparatus for measuring, in a multi-layer film obtained by blow extrusion process and formed of one or more layers of a first material and one or more layers of a second material, the total thickness (L₁) of the first material and/or the total thickness (L₂) of the second material, said apparatus comprising:
an electromagnetic radiation sensor arranged to provide a first measurement signal (Sₓ) representative of the total thickness of the film;
a capacitive sensor arranged to provide a second measurement signal (S_{cap}) which is the sum of the signals given by the first and second materials of the film, wherein the signal given by each material of the film is a function of the thickness (L₁, L₂) of said material; and
processing means for calculating, from said first and second measurement signals (Sₓ, S_{cap}), the total thickness (L₁) of the first material and/or the total thickness (L₂) of the second material.

9. The apparatus according to claim 8, wherein said electromagnetic radiation sensor is an X-ray retro-reflection sensor.

10. A blown film extrusion plant for producing a multi-layer film, comprising an apparatus according to claim 8.

11. The plant according to claim 10, wherein said apparatus further comprises a measuring head on which said electromagnetic radiation sensor and said capacitive sensor are mounted so as to lie in a same plane oriented tangentially with respect to the outer surface of the bubble (B), guide means arranged around said bubble (B), coaxially to said bubble (B), and on which said measuring head is movably mounted along a circular path, and driving means for controlling the movement of said measuring head on said guide means.

12. The plant according to claim 11, wherein said apparatus further comprises an ultrasonic sensor arranged to measure the distance between the plane on which said electromagnetic radiation sensor and said capacitive sensor lie and the outer surface of the bubble (B).
